(19) United States
(12) Patent Application Publication
(10) Pub. No.: US 2002/0074696 A1
(43) Pub. Date: Jun. 20, 2002

(54) Surface modification of vulcanised rubber objects

(76) Inventors: Dong Yang Wu, Victoria (AU); Sheng Li, Victoria (AU); Stuart Bateman, Victoria (AU)

Correspondence Address: PILLSBURY WINTHROP LLP, 1600 TYSONS BOULEVARD, MCLEAN, VA, 22102, US

(21) Appl. No.: 09/948,706

(22) Filed: Sep. 10, 2001

Related U.S. Application Data
(63) Continuation of application No. PCT/AU00/00164, filed on Mar. 8, 2000.

(30) Foreign Application Priority Data
Mar. 10, 1999 (AU) PP9094

(51) Int. Cl. B29C 35/08; B29C 71/02; B29C 71/04

(52) U.S. Cl. 264/446; 264/489; 264/491; 264/83

(57) ABSTRACT

A method of modifying at least part of the surface of a vulcanised rubber object including: (I) treating at least part of a surface of the vulcanised rubber object with at least one halogenating agent to provide a halogenated rubber surface; and (ii) treating the halogenated rubber surface with at least one multi-functional amine-containing organic compound to chemically bind said compound to the halogenated rubber surface; wherein the multifunctional amine containing organic compound consist of the elements carbon, hydrogen and nitrogen and optionally one of more of the elements oxygen, sulphur, halogen and phosphorous.

The present invention relates to a method for chemically tailoring the surface chemistry and molecular structure of vulcanized rubber objects including crumb rubber to optimise their surface bio-compatibility and interaction with other materials such as adhesives, paints, sealants, rubber or polymeric matrices.

In various rubber applications, It is desirable to form a strong and durable bond between the rubber or rubber based material (in the form of flat sheet, film, woven fabric, fibre, web or particulate) and the other part of materials in contact. These materials can be inorganic/organic/polymeric coatings or adhesives, and rubber or polymer matrices. However, it is well known that many vulcanised natural or synthetic rubbers and/or their mixtures with polymers are not compatible with other materials due to the absence of specific surface functional groups and/or molecular structure capable of creating strong interfacial interactions for stress transfer and forming an appropriate interphase structure for stress dissipation.

One of the important areas of applications of the present invention involves tailoring surface chemistry and molecular structure of crumb rubber for the production of high-value engineering composites containing recycled rubber. Approximately 1.6 billion of scrap tires are being generated every year worldwide with less than 5% of them being recycled. Therefore, huge opportunities exist if effective technology is developed to recycle the scrap tire rubber into value added products.

Tyre rubber has many excellent mechanical properties in comparison to other materials. These include impact resistance, flexibility, abrasion resistance, and resistance to degradation. Therefore, the concept of using crumbed tire rubber as an engineering material is justified.

Production of crumb rubber and its utilisation as a raw material is considered to be one of the most energy efficient and environmentally sound methods of recycling scrap tires. Although major breakthroughs achieved in the area of crumb rubber manufacturing technologies has allowed for the production of lower cost and higher quality crumb materials, the crumb rubber market is still relatively small. One of the main obstacles to substantial growth of the recycled rubber market is due to the chemical inertness of the crumb rubber surface. This results in inferior product performance due to lack of chemical compatibility and/or bonding between the chemically inert crumb rubber and the rubber or plastic matrix. Consequently, the untreated crumb rubber has been mainly used to produce low-performance products such as railroad crossing pads, impact-absorbing mats, and garbage bins.

Surface modification opens up new opportunities for recycling scrap tire rubber into high value applications resulting in significant economic and product improvement benefits to industry. This approach consists of chemically modifying the outmost surface of crumb rubber during which, the rubber particle is transformed from a dead filler to a reactive ingredient for effective combination with other virgin rubber or virgin/recycled materials.

In comparison with untreated rubber, the surface of treated crumb rubber becomes more compatible, and forms a stronger bond with the continuous phase rubber or polymers. Consequently, it is possible to use a larger percentage of surface treated crumb rubber in the rubber or plastic compound with minimum detrimental effects commonly experienced in the past with the addition of the untreated rubber particles.

U.S. Pat. No. 4,481,335 by Fred Stark describes the surface treatment of crumb rubber with 1 to 5% by weight of a rubber latex having ethylenic unsaturation and with any of the curing agents commonly used, such as elemental sulfur or sulfur donor compounds. The rubber latex is preferably a homopolymer or copolymer of 1,4-butadiene. The applied rubber latex has a molecular weight of from 1000 to 100,000, and preferably from 1000 to 50,000. The obtained surface treated crumb rubber can be added in a quantity of preferably 25 to 75% by weight to rubber mixtures for producing rubber-like products, wherein the loss of mechanical properties is considerably reduced compared to the application of untreated crumb rubber.

The subsequent PCT application WO 88/02313 of the same applicant as mentioned above relates to a vehicle tire having a tread portion containing 20 to 80% by weight of crumb rubber surface treated by the process of the above US patent specification. The tensile strength and elongation at break properties of the rubber are reduced as a result of the addition of the treated crumb whilst the wear resistance is not affected. For instance, a mixture of 40% by weight of surface treated crumb and 60% by weight of styrene-butadiene rubber compound gives a product with approximately 25% lower tensile strength than that of the virgin styrene-butadiene rubber.

PCT patent application WO 92/10540 by Richard Smith et al involves a surface treatment process for crumb rubber similar to the above two patent applications. The main difference was to use rubber latex for surface treatment instead of dried rubber latex as suggested by Fred Stark previously. The process of this invention has the advantage that a liquid rubber latex is easier to handle and much less viscous than the dried rubber latex suggested in the above US patent specification. Another advantage cited includes the use of rubber latex with a higher molecular weight, which is not possible in the prior art process because a too viscous liquid or a rubber sheet is obtained by drying the latex. It is speculated that the application of rubber latex with a higher molecular weight yields a stronger bond between the surface treated crumb and the virgin rubber matrix. Consequently, the moulding products manufactured from the surface treated crumb possess a higher tensile strength than mouldings produced from crumb treated according to the prior art.

U.S. Pat. Nos. 4,833,205 and 4,771,110 describes a surface treatment process for crumb rubber or other polymer with a gaseous mixture containing a minor amount of fluorine and a larger amount of at least one reactive gas in an inert gaseous carrier. The reactive gas is preferably oxygen or one of the gases from the group consisting of chlorine and SO₂ with or without added oxygen. Chemical functional groups such as hydroxyls, carboxyls, aldehydes, ketones, and esters are formed on the surface of the crumb or polymer as a result of the gas-phase treatment. The treated crumb can be incorporated into a thermoset or thermoplastic material having functionalities reactive towards the acidic hydrogen functionalities on the surface of the treated crumb. Examples of suitable thermoset or thermoplastic materials include epoxide, isocyanate and carboxylic acid anhydride or a precursor, which is hydrolyzable to carboxyl such as carbonyl fluoride.

The surface modification methods suggested by the above-mentioned prior arts generally produce a specific type of crumb rubber surface chemistry, which facilitates the inclusion of the treated crumb rubber in a limited range of rubber or polymer matrix.

This invention provides a versatile means for tailoring surface chemistry and molecular structure of vulcanised rubber including crumb rubber according to the chemical nature of the matrix material and end product performance requirements. We have found that halogenation of at least part of the surface of the vulcanised rubber object including crumb rubber followed by reaction of the halogenated rubber surface with at least one multi-functional amine containing compound allows the rubber surface to be permanently modified with the desired functional groups and molecular structure.

Accordingly the invention provides a method of modifying at least part of the surface of a vulcanised rubber object including:

(i) treating at least part of a surface of the vulcanised rubber object with at least one halogenating agent to provide a halogenated rubber surface; and

(ii) treating the halogenated rubber surface with at least one multi-functional amine-containing organic compound to bind said compound to the halogenated rubber surface.

In a preferred embodiment, the method of invention includes grafting a compound containing acidic group(s) onto the rubber surface through reaction with the multi-functional amine containing organic compound. The specific procedure used in this embodiment of the invention may include halogenation and reacting the halogenated rubber surface either with the multi-functional amine containing compound in the presence of the compound(s) containing acidic group(s) or with the premixture of the multi-functional amine containing compound and the compound containing acidic group(s). Alternatively, reaction with the compound containing acidic group(s) can be carried out upon completion of the reaction between the halogenated rubber surface and the multi-functional amine containing compound. This embodiment provides a modified rubber surface with a grafted double-layer molecular structure and a specific surface chemistry. A multi-layer may be obtained by repeating the above mentioned chemical treatment procedures to satisfy specific physical-chemical, chemical, rheological, and/or biocompatible requirements.

The rubber object used in the process of the invention comprises a rubber surface and may be composed of but not limited to natural rubber, synthetic rubber, a mixture of natural and synthetic rubber, or a mixture of rubber and polymer such as but not limited to thermoplastic elastomers. Suitable examples include but not limited to ethylene propylene diene rubber, synthetic cis-polyisoprene, butyl rubber, nitrile rubber, copolymers of 1,3-butadiene with other monomers such as styrene, acryl nitrile, isobutylene or methylmethacrylate, ethylene-propylene-diene terpolymer, silicon rubber, and PP (polypropylene)-EPDM (Ethylene-Propylene-Diene-Mixture) blends. Typically the rubber object will be in a cured or vulcanised state and may comprise additives or fillers used in compounding rubber materials. Examples of fillers and additives include carbon black, silica, fiber, oils and zinc oxide. The rubber object modified by the present invention may be in any suitable form though it will generally be a solid. For example the rubber object may be in the form of a sheet, film, woven fabric, fiber, web and particulate rubber (e.g. crumb rubber).

The halogenation of the vulcanised rubber surface can be carried out by using halogen containing gases or halogenating agents. The halogenating agents may be applied to the surface of the vulcanised rubber by any suitable method. The mode of treatment will depend upon the state of the halogenating agent used. For example, the halogenating agent may be applied from solution (dip, brush, spray), vapour or any type of mechanical dispersion of a pure chemical or their solutions and/or mixtures in any suitable liquid media.

Any suitable halogenating agent may be used in the method of the invention. Suitable halogenating agents include inorganic and/or organic halogenating chemicals in an aqueous or non-aqueous solvent. The halogenating agents may be present in a single liquid media such as solvent or water or in a mixture of liquids containing solvents or solvent(s) mixed with water.

Preferred organic halogenating agents include various N-halohydantoins, various N-haloimides, various N-haloamides, N-chlorosulphonamides and related compounds, N, N′-dichlorobenzoylene urea and sodium and potassium dichloroisocyanurate. Examples of various N-halohydantoins include 1,3-dichloro-5,5-dimethyl hydantoin; 1,3-dibromo-5,5-dimethyl hydantoin; 1,3-dichloro-5-methyl-5-isobutyl hydantoin; and 1,3-dichloro-5-methyl-5-hexyl hydantoin. Examples of N-haloamides include N-bromoacetamide, tetrachloroglycoluril, and dichloro derivatives of glycoluril. Examples of N-haloimides include N-bromosuccincimide, N-chlorosuccinimide and the various chloro substituted s-triazinetriones, commonly known as mono-, di-, and tri-chloroisocyanuric acid. Examples of N-chlorosuiphonamides and related compounds include chloramine-T. Preferred organic halogenating agents for use in the present invention are the various mono-, di-, or tri-chloroisocyanuric acids, or their combinations. Trichloroisocyanuric acid is especially preferred.

The organic halogenating agents usually exist in solid form, so that various solvents are used for preparing solutions such as esters where the acid portion has from 1 to 5 carbon atoms and the alcohol portion has from 1 to 5 carbon atoms. Examples include methyl acetate, ethyl acetate, ethyl propionate, butyl acetate, and the like, as well as their mixtures. Other solvents that can be used are ethers, ketones, and the like. Solvents reactive towards the halogenating agents such as toluene should be avoided. Ethyl acetate is a particularly preferred solvent for Trichloroisocyanuric acid.

Preferred inorganic halogenating agents for use in the invention include acidified hypochlorite solutions, chlorine in CCl₄, and hydrochloric acid in organic solvents. An acidified aqueous solution of sodium hypochlorite is especially preferred.

The amount or concentration of halogenating agent will depend upon the type of surface to be treated, the method of treatment and the result desired. For example, concentrations of less than 20% by weight of halogenating agents in solution may be used. Preferably, the concentration of halogenating agent is in the range of 0.05% to 5% by weight.

The halogenation step is preferably carried out at a temperature of 0° C. to 100° C. and more preferably the temperature is in the range of from 20 to 100° C. and most preferably from 20 to 60° C. The efficiency of a halogenation reaction may also be optimised by the use of a high frequency alternating physical field such as an ultrasonic, radio frequency or microwave field. The use of ultrasonic energy is particularly preferred and when it is used ultrasonic energy is generally applied with a composition in the above preferred temperature ranges. The high frequency alternating physical field may be applied for a period of time to achieve the desired result and typically times in the range of 0.1 second to 24 h and most preferably from 10 to 30 seconds.

The second step of the invention involves treatment of the surface of the halogenated rubber object with a multi-functional amine containing organic compound. The multifunctional amine containing organic compound is at least a carbon, hydrogen and nitrogen containing compound which either has at least two amine groups or has one or more amine group(s) and at least one functional group other than the amine functional group(s). The compound may also contain one or more of the elements such as oxygen, sulphur, halogen and phosphorous in addition to carbon, hydrogen and nitrogen but generally will not contain silicon, titanium, zirconium or aluminium which are the basis of conventional coupling agents. The multifunctional amine compound will preferably contain at least one amine group. Examples of multi-functional amine containing compounds having at least one amino group include compounds of groups A, B and C, wherein group A includes low and/or high molecular weight organic/polymeric amines, that is compounds containing two or more amine functional groups. The amines can be primary, secondary, and/or tertiary amines, or a mixture of these three types of amines, however, primary and secondary amines are preferred due to their higher chemical reactivities in comparison with the tertiary amines. Group B chemicals include multi-functional organic compounds in which at least one amine functional group and one or more non-amine functional groups are presented. Typically at least one amine group will be other than a nitrogen heterocyclic group. The non-amine functional groups include, but are not limited to, the following functional groups and their mixtures: perfluorohydrocarbons, unsaturated hydrocarbons, esters, hydroxyls/phenols, carboxyls, amides, ethers, aldehydes/ketones, nitrites, nitros, thiols, phosphoric acids, sulfonic acids, halogens, azo, azide, azido and combinations of two or more thereof. Group C chemicals include multi-functional compounds in which at least one amine group and one or more radical generating functional groups are presented. The radical generating groups which produce free radicals under heat or light application include, but are not limited to, the following functional groups and their mixtures: azo, azide, azido, peroxide, etc. More specifically, the groups include, but are not limited to, any of the following chemical moieties:

AI: linear and carbon cyclic based multi-functional amine (at least diamine) compounds containing 2 to 60 carbon atoms, preferably 2 to 36 carbon atoms

eg. diamino propane, diamino butane, diamino pentane, diamino hexane, diamino octane, diamino decane, diamino nonane, dimino dodecane, hexamethylene diamine, pentaethylene hexamine, triamino pyrimidine, 1,2-diaminocyclohexane, etc;

AII: polymer or copolymer containing a multiplicity of amine functional groups such as polyamine compounds with molecular weight ranging from a few hundreds to a few millions

eg. polyethyleneimine, polyallylamine, polyvinylamine, amine-terminated acrylonitrile-butadiene-styrene (ATBN)etc;

BI: Perfluoroamines: e.g. perfluoroethylamine, perfluorotributylamine, etc;

BII: Amino alcohols/phenols: e.g. 2-amino ethanol, 6-amino-1-hexanol, 2-amino-2-methyl-propanol, 2-amino-2-ethyl-1,3-propanol, 4-aminophenol, etc;

BIII: Amino polysaccharides: amino dextran, etc;

BIV: Amino acids: e.g. 4-amino butyric acid, amino undecanoic acid, diamino butylic acid, 5-amino salicylic acid, etc;

BV: Amino aldehydes/ketone: amino acetaldehyde (H₂NCH₂CHO), 1,3,di-amino acetone, etc;

BVI: Amino amides: amino acetamide (H₂NCH₂CONH₂), poly(acrylic 6-acid 6-aminohexyl amide), amino butene thioamide, etc;

BVII: Amino ethers: e.g. 3-aminopropyl-n-butylether, 3-amino-1-propanol-vinylether, etc;

BVIII: Amino esters: e.g. ethyl-4-aminobutyrate, etc;

BVIIII: Amino nitriles: e.g. β-aminopropionitrile, methoxylaminoacetonitriie, diamino maleonitrile, etc;

BX: Amino nitros: e.g. amino nitropyridine, etc;

BXI: Amino thiols: e.g. 1 -amino-2-methyl-2-propanethiol, etc; butylaminoethanethiol, etc;

BXII: Amino phosphoric acids: amino propyl phosphoric acid, amino phosphonobutyric acid, aminobenzyl phosphoric acid, etc;

BXIII: Amino sulfonic acids: 3-amino-1-propane sulfonic acid, amino benzene sulfonic acid, etc;

BXIV: Amino halogens: amino chlorobenzyl alcohol, polyethyleneimine-epichloro hydrin modified etc;

BXV: Amino alkenes, amino alkynes: allyamine, diallyamine, triallyamine, etc.

CI: Amino alkoxy amines: 1-hydroxy-2-(N-oxy-(2,2,6,6-tetramethyl piperidinyl) amino ethylacrylate, 1-hydroxy-2-(N-oxy-(2,2,6,6 - tetramethyl piperidinyl) amino ethylacrylamide, etc;

CII: Amino esters: 4-amino-N-(2-thiopiperidinyl)butanoate, 6-amino-N-(2-thiopiperidinyl)hexanoate, etc;

CIII: Amino peroxides: amino succinic acid peroxide, amino benzoyl peroxide, etc;

CIV: Amino azides and amino azos and amino azidos: 2,2′-azobis(2-methyl propionamidine), azodicarbonamide, azido sulfonylaniline, etc.

All the compounds in class B (BI to BXV) and class C (CI to CIV) may contain from 2 to 60 carbon atoms, preferably, from 2 to 36 carbon atoms in the case of low molecular weight compounds, and in the case where a polymeric compound is involved, the molecular weight of the compound may range from a few hundreds to a few millions.

Any suitable concentration of the amine-containing compound may be applied dependent upon the type of surface to be treated, the method of treatment and the level of surface treatment desired. For example, concentrations of less than 20% by weight of an amine-containing compound may be used. Preferably, the concentration of the amine-containing compound is in the range of 0.01% to 10% by weight.

The amine-containing compound may be applied for any suitable time period from 0.0001 seconds to 24 hours at any suitable temperature from room temperature up to, and above the boiling point of these compounds. Preferably, the compounds are applied for 0.01 to 5 mins at 20 to 50° C.

The acidic group containing compound as used in the present invention in conjunction the multi-functional amine containing compound for achieving double or multi-layer surface grafting as specified previously in one of the preferred embodiment of the invention include compounds having at least one of the following acidic group or their hydrolysable salts such as, but not limited to, carboxylic/carboxylate, sulfonic/sulfonate, phosphoric/phosphonate and acid halide (e.g. acid chloride) groups. The compounds may also contain more than one type of acidic groups as well as other organic functional groups such as hydroxyl, amine, amide, ether, ester, ketone, aldehyde, halogen, azo, azido, peroxide, etc, in their molecular structures. The acidic groups containing compounds can be small molecules with 2 to 60 carbon atoms, or macromolecules with molecular weight ranged from a few hundreds to a few millions. It is preferred that more than one acidic group be included in the molecular structure of the acidic groups containing compounds.

Preferably the acid group containing compound is selected from the group consisting of: polymers of monomers selected from the group consisting of acrylic acid, methacrylic acid, p-styrene carboxylic acid, 4-methacryloyloxyethyl trimellitate, vinyl sulphonic acid, p-styrene sulfonic acid, melaphosphonic acid; and copolymers including one or more thereof; and polysaccharide derivatives containing sulfonic/sulphonate and carboxylic/carboxylate groups.

Examples of the acidic groups containing compounds are as follows: carboxylic acid containing compounds (e.g. polyacrylic acid, polysaccharide derivatives containing carboxyl or carboxylate groups, polymethacrylic acid, poly(acrylic acid-co-maleic acid), poly(p-styrene carboxylic acid), poly(40methacryloyloxyethyl trimellitate), 4,4′-azobis(4-cyanovaleric acid), succinic acid peroxide); sulfonic acid containing compounds (e.g. polysaccharide derivates containing sulfonic acid or sulfonate groups, poly(vinylsulfonic acid), poly(p-styrenesulfonic acid)); and/or phosphoric/phosphonic acid containing compounds (poly(metaphosphoric acid)). Suitable acid chloride azo compounds are described in U.S. Pat. No. 4,101,522. The concentration of the solution containing compounds having acidic groups is preferably 0.000001% to 10% by weight, or more preferably when it is 0.01% to less than 5% by weight. When the concentration is 0.5% by weight or more, said unreacted or excessive composition is optionally washed from the treated polymer substrate prior to drying and further end-applications.

All of the multi-functional organic amine containing compounds included in groups A, B, and C, and the acidic groups containing compounds may be applied from solution (dip, brush, spray), vapour or any type of mechanical dispersion of a pure chemical or their solutions and/or mixtures in any suitable liquid media. According to the invention, any aqueous and/or organic solvent or a mixture of both may be used to prepare the reactive solutions so long as it does not attack the substrate and permits sufficient dissolution of the amine containing compounds claimed in this invention. Preferred solvents used for preparing the solution are water, and alcohols (ie. isopropyl alcohol, and ethanol).

For a given application, one or more multi-functional organic amine containing compound may be chosen in which the functional groups grafted onto the rubber surface have controlled or maximised reactivity at the interface. For example, if the substrate to be modified is to be bonded to a cyanoacrylate adhesive, a multi-functional organic amine would be selected in order to equip the polymer surface with the nucleophilic free amine groups which then initiate the cure and react with the adhesive during bonding and curing of the adhesive.

In one of the embodiments of the present invention, a suitable static and/or high frequency alternating physical field may be simultaneously applied to the organic amine containing compound and/or to the substrate during the surface treatment process. For example, any one of the following fields may be used: ultrasonic, microwave, radio-frequency, heat energy or a combination thereof. Preferably an ultrasonic field and/or microwave is used.

According to the invention, optional chemical functional groups become attached to a rubber substrate surface by subsequently dipping the halogenated substrate into a composition containing the amine(s) with or without the simultaneous application of ultrasonic energy to the solution. The advantages provided by simultaneous application of ultrasonic field and/or microwave during the step (ii) of the treatment is to accelerate and promote the attachment of the selected chemical compound onto the polymer surface in order to obtain a modified surface with stabilised and improved physical and chemical properties. Further, the simultaneous application of an ultrasonic energy during the treatment may also improve the orientation of the adsorbed molecules.

The preferred frequency range of ultrasonic energy field ranges between 1 to 500 kHz, more preferably between 10 to 50 kHz.

Preferably when used microwave energy is applied in the range of from 1 ghz to 300 ghz.

The present invention generally may be used to: 1) control or enhance the bonding ability of the vulcanised rubber object to other materials including, but not limited to adhesives, sealants, coatings and any other reactive and/or non-reactive organic, inorganic or metallic materials, or mixtures thereof; 2) control surface energies and/or wettability there with render hydrophobic rubber objects hydrophilic or vice-versa; (3) improve composite performance through the surfaces of the rubber reinforcing materials (e.g. crumb rubber) being chemically modified according to the present invention in order to achieve controlled or maximised adhesion and rheological properties at the rubber particulate/matrix interfaces; (4) improve biocompatibility of rubber materials for various biomedical applications.

Following the treatment of the vulcanised rubber object by the method of the invention the treated surface may be adhesively bonded to another substrate or coated.

When adhesively bonded to another substrate any suitable adhesive may be applied to the treated rubber surface and then the other substrate is brought into contact with the adhesive. Suitable adhesives include, for example, cyanoacrylates, structural acrylic, epoxy, polyurethane, silicone sealants, pressure sensitive adhesives, unsaturated polyester, contact adhesives, polymer cements, or thermoplastic adhesives. Examples of particular suitable adhesives include, but are not limited to Cyanoacrylates Loctite 406, Loctit 454, acrylic Permabond F241, epoxy Araldite 138, polyurethane Tyrite 7520 A/B. Preferably the adhesive will be cured at a temperature lower than 300° C.

Alternatively, any suitable contact adhesive such as, but not limited to, self adhesive tape may be applied to the treated rubber surface and then the other substrate may be brought into contact with the tape.

One of the applications of the present invention also involves application of a coating composition to the treated rubber object. The coating composition may be a metallic or a solid based paint, lacquer, varnish, enamel, water-emulsion, non-aqueous dispersion (organosol), plastisol or powder coating, radiation curable coating, and sputter coating.

When the treated substrate is printed with ink, any suitable ink may be used.

Similarly, when the treated substrate is coated with a metallic material, any suitable metallic material may be used. Also, any coatings, based on aqueous and/or organic carrier and containing magnetic particles such as used in voice and/or image recording may be applied onto the substrate treated in accordance with our invention.

The present method of invention can also be applied to modify rubber surfaces in order to achieve controlled level of hydrophilicity of hydrophobicity for various technological/biological requirements in the areas, but not limited to, controlled evaporation/heat transfer, printing, release/decorative coatings, etc.

The invention allows the wettability of rubber surfaces to be controlled by using an appropriate multifunctional amine-containing organic compound and optionally also the acid group containing compound. For example

(i) when the treated rubber surface is hydrophilic providing a wettable surface and a water contact angle equal or less than 60°0; and

(ii) when the treated rubber surface is hydrophobic providing a non-wettable surface of water contact angle equal or greater than 90°.

Hydrophobic rubbers are commonly used as impact protection or seals or coatings to protect metal surface from tarnishing or corroding or for providing an attractive finish. Such rubber products are widely used in the building and automotive industries. The hydrophobic nature of the rubber is particularly useful in these applications as it provides an effective moisture barrier. Notwithstanding this advantage, however, hydrophobicity of the rubber surface makes it insusceptible to painting or coating for decorative purposes. Another potential problem associated with the hydrophobic nature of the rubber surface in such applications is due to the formation of water beads when the surface is exposed to nature weathering conditions. The water beads on the rubber surface tend to dry to form unsightly marks. The effect of the dried water beads on the rubber surface is particularly detrimental in the presence of dust, dirt or salts.

The present invention enables the hydrophobic rubber surface to be treated to become susceptible to decorative coatings, or to be hydrophilic enough to avoid the formation of water beads on the surface. Therefore, the invention has the advantage that it allows the aesthetics of the rubber coating surface to be improved without compromising the required bulk properties of the rubber coating, or the need to change the current rubber coating processes or the metal substrate used.

It is generally established that the contact angle of water on a wettable surface should be lower than 600 and preferably is below 45° C. This is not easy to achieve on a number of substrate surfaces with conventional surface oxidation methods such as corona discharge, flame treatment and even non-depositing plasma treatments.

Indeed we have found that, in contrast to the halogenation step of the present invention, the conventional surface oxidation methods such as corona discharge and flame treatment are not effective in chemical modification of vulcanised rubber object.

Therefore, the combination of a simple halogenation method and post-chemical grafting either by a 2-steps or a 3-steps process as specified in the present invention will provide effective, stable and low cost surfaces with a controlled degree of hydrophilic or hydrophobic property to meet variable application requirements.

Subsequent to the treatment of a rubber object by the method of the current invention the treated surface may be used for the various biomedical applications. Medical products made by use of the modified rubber materials include, but not limited to, the following applications: blood purification systems such as blood oxygenator for artificial lung, hemodialyzer and hemofilter for artificial kidney, filters for plasmapheresis or virus removal, adsorption column for detoxification, cell separator, immuno activator; Prosthesis such as blood access, vascular prosthesis, patch grafting, artificial cornea, artificial heart valve, blood pump for heart assist, contact lens, intraocular lens, bypass tube, catheter of hyperalimentation, hydrocephalus shunt, implants in plastic surgery, prosthesis and implants in dental surgery, wound dressing or covering; Disposable articles such as Catheters, tubing, haemostatics, adhesives, syringe, suture.

Another important area involving the present invention consists of manufacturing composites containing vulcanized including recycled rubber particles dispersed in inorganic, organic/polymeric or rubbery matrices. Because the vulcanised rubber is a thermoset polymer, it can't simply be melted down and moulded into new products as can be done with thermoplastic polymers. Untreated crumb rubber particles can be mixed with resins and glue for some limited uses, but the end products tend to have lower performance specifications, and consequently lower economic values due to the physical nature of the bonding at the composite interface. The present invention is capable of chemically tailoring the outer few molecular layers of rubber particles, enabling them to be favourably combined with other inorganic, organic/polymeric or rubber materials to achieve a desired and/or maximised mechanical performance.

Accordingly we provide in a further aspect of the invention a process for forming a rubber composite from particulate vulcanised rubber comprising:

(i) halogenating particulate vulcanised rubber with at least one halogenating agent to provide a halogenated surface;

(ii) treating the halogenated rubber surface with at least one multifunctional amine containing organic compound to bind said compound to the halogenated rubber surface; and

(iii) compounding the particulate vulcanised rubber with a matrix material to provide a composite containing particulate vulcanised rubber in a matrix of said matrix material.

The surface treated rubber particulate can be added into the matrix material either alone or in combination with other suitable additives including curing agents such as sulfur and/or sulfur donors. Examples of inorganic, organic/polymeric or rubber matrix materials include, but not limited to polymers or copolymers of acetals, acrylics, epoxy, latex polymers, melamines, nylons, phenolics, polycarbonates, polyesters, polyolefins (including, but not limited to, homopolymer of polyethylene of various densities, polypropylene and their blends and copolymers, and functionalised polyolefins with maleic anhydride, glycidyl methacrylate, etc), functionalised or non-functionalised polystyrene, polysulfones, polysulfides, polyurethanes, polyvinyl alcohol, polyvinyl chloride, poly(acrylonitrile-butadiene-styrene) (ABS), unvulcanized rubbers, silicons, unsaturated polyesters, urea formaldehydes, polymethyl methacrylate (PMMA), bitumen, asphalt, concrete and natural and synthetic rubbers, and mixtures of two or more thereof. The crumb rubber containing composites may be fabricated by any processing techniques known in the art such as but not limited to extrusion, injection moulding, blow moulding, compression moulding. Any suitable additives may also be added into the composites prior to or during any stage of the composite process. These include but not limited to UV/thermal stabilisers, curatives, and catalysts for promoting interface bonding between the treated crumb rubber surface and the rubber or polymer matrix. For instance, a catalyst of Lewis acid such as aluminium chloride was found to be effective in promoting the formation of interfacial bonding between surface treated crumb rubber according to the present invention and an ABS matrix material.

The invention will now be described in greater detail in conjunction with specific examples. It will be appreciated that the examples are provided for the purposes of illustrating the invention and that they in no way should be seen as limiting the scope of the above description.

### EXAMPLE 1

The effectiveness of the present invention is demonstrated with the following experiments involving blend of natural rubber (NR)/SBR as the substrate.

The surface of the rubber was treated by the following alternative means:

1. Untreated with ethanol wipe only

2. Surface chlorination by Immersion in 0.5% acidified sodium hyprochloride (NaOCl) solution (with the addition of 2% acid chloride) in water.

3. Surface grafting with amino groups by chlorination as described in “2”, followed by immersion in a 0.25% aqueous solution of polyethyleneimine (PEI) (Mn=750,000) or a 0.25% aqueous solution of polyallylamine (PAA) (Mn=8500).

The surface treated rubber strips were then assembled with the maleated polypropylene (PP) in such a way that two rubber pieces were put on the outside with the maleated polyolefin piece being placed in the middle of the assembly to form a sandwich structure. The whole assemblies were then pressed by an hydraulic press at 180° C. for 15 mins. Peel strength of the rubber specimens bonded to the maleated polypropylene was determined by 180° peel test in accordance with an ASTM-C794 Standard.

The results of the experiments are reported in Table 1.

TABLE 1
Peel strength of untreated and various surface treated
rubber bonded to the maleated PP

| | Peel strength | |
|---|---|---|
| Rubber surface treatment | (J/m²) | % CF* |
| Untreated | 0 | 0 |
| Chlorinated | 160 | 0 |
| Chlorination + PEI | 4800 | 100 |
| Chlorination + PAA | 4667 | 100 |

*Percentage of cohesive failure within the rubber substrate

The results in Table 1 clearly indicate that there is no adhesion between the untreated rubber surface and the maleated polypropylene. Surface chlorination of the rubber by acidified NaOCl solution alone leads to limited increase in the peel strength with still a 100% delamination. Rubber surface amination subsequent to the surface chlorination by the attachment of either polyethleneimine molecules or polyallylamine molecules results in, not only remakeable increase of the peel strength, but also 100% cohesive failure occurring within the rubber substrates. The significant enhancement of the adhesion between the aminated rubber surface and the maleated polypropylene can be attributed to the formation of strong covalent bonding at the interface through the chemical reaction between the amino groups on the rubber surface and the maleic anhydride groups of the maleated polypropylene material.

### EXAMPLE 2

The effectiveness of the present invention is demonstrated with the following experiments involving blend of natural rubber (NR)/SBR (Pirelli rubber) as the substrates.

The surface of the rubber was treated by the following alternative means:

1. Untreated with ethanol wipe only

2. Surface chlorination by Immersion in 2% acidified sodium hyprochloride (NaOCl) solution (with the addition of 2% acid chloride) in water, followed by immersion in a 0.25% aqueous solution of the following individual chemical: polyethyleneimine (PEI), polyallylamine (PAA), and 1,2-diamino propane.

Following the above treatment, the specimens subsequently bonded with an epoxy adhesive (Araldite 138, Ciba Geigy), the bond strengths were tested. Peel strength of the bonded specimens was determined by 180° peel test in accordance with an ASTM-C794 Standard.

The results of the experiments are reported in Table 2.

TABLE 2
Peel strength of untreated and surface treated
rubber bonded to the epoxy adhesive

| | Peel Strength |
|---|---|
| Rubber surface treatment | (J/m²) |
| Untreated | 0 |
| Chlorination + 1,2-diamino propane | 2933 |
| Chlorination + PEI | 4240 |
| Chlorination + PAA | 3893 |

The results in Table 2 show that there is no adhesion between the untreated rubber surface and the polar epoxy adhesive due to poor wettability and lack of strong interfacial bonding. Grafting of a diamino compound such as 1,2-diamino propane onto the rubber surface provides improvement of adhesion because one end of amine is attached onto the chlorinated surface whilst another end of amine groups are reactive towards to adhesion to form a strong bonding. Rubber surface amination subsequent to the surface chlorination by the attachment of a multi-amine containing compound such as polyethlene imine or polyallylamine molecule results in, not only further increase of the peel strength, but also 100% cohesive failure occurring within the rubber substrates. This may be attributed to a higher amino content on the surface and a more favourable molecular structure at the interphase region.

### EXAMPLE 3

The effectiveness of the present invention is demonstrated with the following experiments involving blend of natural rubber (NR)/SBR (Pirelli rubber) as the substrates.

The surface of the rubber was treated by the following alternative means:

1. Untreated with ethanol wipe only

2. Surface chlorination by Immersion in 2% acidified sodium hyprochloride (NaOCl) solution (with the addition of 2% acid chloride) in water, followed by immersion in a 0.25% aqueous solution of the following individual chemical: polyethyleneimine (PEI), polyallylamine (PAA).

Following the above treatment, the specimens subsequently bonded with a polyurethane adhesive (Tyrite 7520, Lord Corporation), the bond strengths were tested. Peel strength of the bonded specimens was determined by 180° peel test in accordance with an ASTM-C794 Standard.

The results of the experiments are reported in Table 3.

TABLE 3
Peel strength of untreated and surfaced treated
rubber bonded to the polyurethane adhesive

| | Peel Strength |
|---|---|
| Rubber surface treatment | (J/m²) |
| Untreated | 0 |
| Chlorination + PEI | 4933 |
| Chlorination + PAA | 4080 |

Again, the results in Table 3 show that there is no adhesion between the untreated rubber surface and the polyurethane adhesive. Grafting of the multiple amine-containing compounds onto the chlorinated surface leads to significant improvement of adhesion due to the formation of bonding between the multi-amine groups on the treated rubber-surface and the polyurethane adhesive.

### EXAMPLE 4

440 micron crumb rubber was treated under the following conditions:

1. Surface chlorination with either 2% Sodium Hypochlorite (NaOCl) and 0.5% Hydrochloric acid (HCl) or 0.5% NaOCl and 2% HCl

2. Surface chlorination as above, followed by surface grafting with 0.25% Polyethylene imine in water

The surface treated crumb was dried in an oven at 40° C. overnight prior to use in composite fabrication.

The untreated or various surface treated crumb were mixed at 25% wt. with the polyurethane matrix (WRM 85 C casting kit supplied by Uniroyal Chemical Pty Ltd), followed by compression moulding of the composite specimens. Tensile strength and elongation at break were measured for each of the composites. The results are reported in Table 4.

TABLE 4
Tensile strength, tensile modulus and elongation at break of
crumb rubber (440 micron, 25%)/Polyurethane (75%) composites

| | | | Elonga- |
|---|---|---|---|
| | Tensile | Tensile | tion |
| | strength | Modulus | at break |
| Crumb treatment | (Mpa) | (MPa) | (%) |
| Untreated | 4.1 | 17.7 | 224 |
| Chlorination with 0.5% NaOCl/2% HCl | 4.7 | 17.8 | 208 |
| Chlorination with 2% NaOCl/0.5% HCl | 5.5 | 17.9 | 204 |
| Chlorination with 2% NaOCl/0.5% HCl, | 6.3 | 17.4 | 241 |
| followed by 0.25% PEI grafting | | | |

From the results given in Table 4, it is seen that by treatment of the crumb rubber particles with the present method of invention (e.g. chlorination+0.25% PEI), superior tensile strength and elongation properties can be achieved without compromising the modulus of the composite material. Optimisation of the chlorination prior to attachment of the graft molecules may also contribute to a higher level of improvement of the mechanical properties of the crumb rubber containing composites.

### EXAMPLE 5

Crumb rubber particles of 600 micron were used in the following conditions:

1. Untreated

2. Surface treatments by chlorination with a 0.5% NaOCl/2% HCl aqueous solution

3. Surface chlorination as “2”, followed by treating with a 5% amine-terminated Acrylonitrile-Styrene-Butadiene (ATBN 1300X42, Goodrich) solution in ethyl acetate.

The results are reported in Table 5.

TABLE 5
Mechanical properties of Crumb rubber (50%)/Rubber (50%)
composites

| | | Tensile | Modulus | Toughness |
|---|---|---|---|---|
| Crumb treatment | Curative | strength (MPa) | (MPa) | (MPa) |
| Untreated | None | 3.5 | 1.1 | 456 |
| 0.5% NaOCl/2% | None | 2.1 | 1.7 | 360 |
| HCl | | | | |
| 0.5% NaOCl/2% | None | 5.5 | 1.4 | 503 |
| HCl + 5% ATBN | | | | |
| 0.5% NaOCl/2% | 2% Sulfur + | 7.4 | 2.2 | 378 |
| HCl + 5% ATBN | 0.75% TBBS | | | |

The results in Table 5 shows that there are increases of tensile strength and elongation properties of the crumb rubber/rubber composites as a result of the two steps treatment, e.g. chlorination+ATBN as described in the present invention. Addition of a small amount of curatives into the composites leads to further increase of tensile strength and modulus possibly due to further cross-linking of the material.

### EXAMPLE 6

Crumb rubber particles of 250 micron and 440 micron were used in the following conditions:

Untreated

Surface treatments in accordance with the invention with a 2% NaOCl/1 % HCl aqueous solution followed by treatment with a 0.25% amine-terminated Acrylonitrile-Styrene-Butadiene (ATBN) solution in ethyl acetate.

The crumb rubber/ABS (Acrylonitrile-Butadiene-Styrene, pipe grade) composites were compounded by extrusion, followed by compression moulding. The mechanical properties of the composites were determined by tensile tests. The results are shown in Table 6.

TABLE 6
Tensile strength, Young's modulus and toughness of
crumb rubber (50%)/ABS (50%) composites

| | | Tensile | | |
|---|---|---|---|---|
| Crumb | | strength | Modulus | Toughness |
| size | Crumb treatment | (MPa) | (MPa) | (MPa) |
| 440 | Untreated | 9.0 | 492 | 0.57 |
| Micron | 2% NaOCl/1% HCl + ATBN | 10.4 | 603 | 0.86 |
| 250 | Untreated | 9.2 | 545 | 0.58 |
| Micron | 2% NaOCl/1% HCl + ATBN | 10.7 | 599 | 0.90 |

Surface treatment of crumb rubber with chlorination and subsequent attachment of ATBN molecules provides a significant improvement in the mechanical performance of the crumb rubber/ABS composites due to optimised interfacial bonding and the presence of a compatible interphase with the ABS matrix.

### EXAMPLE 7

Crumb rubber particles of 250 micron and 440 micron were used in the following conditions:

1. Untreated

2. Surface treatments in accordance with the invention with various chlorination conditions, followed by treatment with a 0.25% amine-terminated Acrylonitrile-Styrene-Butadiene (ATBN) solution in ethyl acetate.

3. Surface treatments as in “2”, followed by addition of 1% aluminium chloride AlCl3 catalyst during the extrusion process

The crumb rubber/ABS (Acrylonitrile-Butadiene-Styrene, pipe grade) composites were compounded by extrusion, followed by compression moulding. The mechanical properties of the composites were determined by tensile tests. The results are shown in Table 7.

TABLE 7
Tensile strength, Young's modulus and toughness of
crumb rubber (50%)/ABS (50%) composites

| | | Tensile | | |
|---|---|---|---|---|
| Crumb | | strength | Modulus | Toughness |
| size | Crumb treatment | (MPa) | (MPa) | (MPa) |
| 440 | Untreated | 9.0 | 492 | 0.57 |
| Micron | 2%NaOCl/1% HCl + ATBN | 10.4 | 603 | 0.86 |
| | 2% NaOCl/1% HCl + | 10.5 | 622 | 0.78 |
| | ATBN + AlCl₃ | | | |
| 250 | Untreated | 9.2 | 545 | 0.58 |
| Micron | 2% NaOCl/1% HCl + ATBN | 10.9 | 582 | 0.90 |
| | 2% NaOCl/1% HCl + | 10.8 | 669 | 1.00 |
| | ATBN + AlCl₃ | | | |

The results in Table 7 indicate that the combination of crumb rubber treatment by chlorination and ATBN grafting and addition of a Lewis acid catalyst such as AlCl₃ during compounding promotes the formation of the interfacial bonding. This leads to further enhancement of the mechanical performance in particular the modulus of the materials.

### EXAMPLE 8

250 micron crumb rubber was either used as untreated or surface treated by 2% Sodium Hypochlorite (NaOCl)/0.5% Hydrochloric acid (HCl), followed by surface grafting with 0.25% 2,2′-azobis(2-methylpropionamidine) synthesised in our laboratory.

Composites containing 50% untreated or surface treated crumb rubber and 50% LDPE were injection moulded. The mechanical properties of these composites are summarised in Table 8.

TABLE 8
Tensile strength and tensile modulus of crumb rubber
(250 micron, 50%)/LDPE (50%) composites

| | Tensile strength | Tensile Modulus |
|---|---|---|
| Crumb surface treatment | (MPa) | (MPa) |
| Untreated | 6.4 | 80 |
| Chlorination with 2% NaOCl + | 7.2 | 113 |
| 0.5% HCl + 0.25% 2,2′-azobis | | |
| (2-methylpropionamidine) | | |

The results in Table 8 show that grafting of a radical initiator onto the crumb rubber surface through the invention leads to increases in tensile strength and modulus of the composites. The radical initiators grafted onto the crumb rubber surface are expected to chemically react with the LDPE matrix through radical reaction initiated by the heat application during extrusion and injection moulding processes.

It is to be understood that the invention described herein above is susceptible to variations, modifications and/or additions other than those specifically described and that the invention includes all such variations, modifications and/or additions, which fall within the spirit and scope of the above description.

1. A method of modifying at least part of the surface of a vulcanised rubber object including:
(i) treating at least part of a surface of the vulcanised rubber object with at least one halogenating agent to provide a halogenated rubber surface; and
(ii) treating the halogenated rubber surface with at least one multi-functional amine-containing organic compound to chemically bind said compound to the halogenated rubber surface;
wherein the multifunctional amine containing organic compound consists of the elements carbon, hydrogen and nitrogen and optionally one or more of the elements oxygen, sulphur, halogen and phosphorous.

2. A process according to claim 1 further including reacting a compound containing one or more acidic groups with the multifunctional amine containing organic compound to graft the compound containing one or more acid groups to the halogenated rubber surface.

3. A process according to claim 2 wherein the halogenated rubber surface is reacted with the multifunctional amine containing organic compound in the presence of the compound containing one or more acidic groups.

4. A process according to claim 2 wherein the compound containing at least one acidic group is reacted with multifunctional amine containing organic compound which has been bound to the halogenated rubber surface.

5. A process according to claim 1 wherein the vulcanised rubber includes one or more vulcanised rubbers selected from the group consisting of natural rubber, synthetic rubber, a mixture of natural and synthetic rubber, and optionally further includes a thermoplastic elastomer.

6. A process according to claim 1 wherein the vulcanised rubber object includes one or more rubber selected from the group consisting of natural rubber ethylene propylene diene rubber, synthetic cis-polyisoprene, butyl rubber, nitrile rubber, copolymers of 1,3-butadiene with other monomers such as styrene, acryl nitrile, isobutylene or methylmethacrylate, ethylene-propylene-diene terpolymer, silicon rubber, and PP (polypropylene)-EPDM (Ethylene-Propylene-Diene-Mixture) blends.

7. A process according to claim 1 wherein the halogenating agent is selected from the group of acidified hypochlorite solutions, chlorine and hydrochloric acid in an organic solvent, chlorine or fluorine containing gases and mixtures of two or more thereof.

8. A process according to claim 7 wherein the concentration of the halogenating agent is in the range of from 0.05 to 5% by weight and the halogenating treatment is carried out at temperature from 0 to 100° C.

9. A process according to claim 1 wherein the step of treating the surface of the vulcanised rubber object with a halogenating agent is carried out in the presence of a high frequency alternating physical field selected from a ultrasonic radio frequency and microwave field.

10. A process according to claim 1 wherein the multifunctional amine containing organic compound is applied from a solution in a solvent having a concentration of from 0.01 to 10% by weight.

11. A process according to claim 1 wherein the multifunctional amine containing organic compound includes at least one primary or secondary amine group.

12. A process according to claim 1 wherein the multifunctional amine containing organic compound includes at least one amine group and one or more functional group selected from the group consisting of perfluorohydrocarbon, unsaturated hydrocarbon, esters, hydroxyl, phenol carboxyl, amide, ether, aldehyde, ketone nitrile, nitro, thiol, phosphoric acid, sulphonic acid, halogen azide, peroxide, azido, azo and mixtures thereof.

13. A method according to claim 1 wherein the multifunctional amine containing compound is selected from the group consisting of: C₂ to C₃₆ linear, branched or cyclic compounds containing two or more amine groups; polymers of a number average molecular weight of from 300 to 3 million containing a multiplicity of amine groups; C₂ to C₃₆ perfluoroamines; C₂ to C₃₆ amino alcohols/phenols; C₂ to C₃₆ amino acids; C₂ to C₃₆ amino aldehydes/ketones; C₂ to C₃₆ amino amides; C₂ to C₃₆ amino ethers; C₂ to C₃₆ amino esters; C₂ to C₃₆ amino nitros; C₂ to C₃₆ amino nitriles; C₂ to C₃₆ amino thiols; C₂ to C₃₆ amino phosphoric acids; and C₂ to C₃₆ amino sulfonic acids; C₂ to C₃₆ amino halogens; C₂ to C₃₆ amino alkenes; C₂ to C₃₆ amino alkynes; C₂ to C₃₆ amino alkoxy amines; C₂ to C₃₆ amino esters; C₂ to C₃₆ amino peroxides; C₂ to C₃₆ amino azides/azos/azidos; polymers of a number average molecular weight of from 300 to 3 million containing a multiplicity of amine groups and non-amine functional groups; and amino polysaccharides.

14. A method according to claim 4 wherein said compound containing at least one acid group is selected from polymers of monomers selected from the group consisting of acrylic acid, methacrylic acid, p-styrene carboxylic acid, 4-methacryloyloxyethyl trimellitate, vinyl sulphonic acid, p-styrene sulfonic acid, melaphosphonic acid; and copolymers including -one or more thereof; and polysaccharide derivatives containing sulfonic/sulphonate and carboxylic/carboxylate groups.

15. A method according to claim 1 wherein the treated halogenated surface having at least one multifunctional surface having at least one multifunctional amine containing surface bond thereto is subjected to adhesive bonding to another objection.

16. A method according to claim 15 wherein the adhesive bonding uses one or more adhesives selected from the group consisting of cyanoacrylates, structural acrylic, epoxy, polyurethane, silicone sealants, pressure sensitive adhesives, unsaturated polyester, contact adhesives, polymer cements, or thermoplastic adhesives.

17. A process according to claim 1 wherein the treated halogenated surface having at least one multifunctional amine containing organic compound bound thereto is coated with a coating selected from the group consisting of metallic or a solid based paint, lacquer, varnish, enamel, water-emulsion, non-aqueous dispersion (organosol), plastisol or powder coating, radiation curable coating, and sputter coating.

18. A process for forming a rubber composite from particulate vulcanised rubber comprising:
halogenating particulate vulcanised rubber with at least one halogenating agent to provide a halogenated surface;
(ii) treating the halogenated rubber surface with at least one multifunctional amine containing organic compound to bind said compound to the halogenated rubber surface; and
(ii) compounding the particulate vulcanised rubber with a matrix material to provide a composite containing particulate vulcanised rubber in a matrix of said matrix material.

19. A process according to claim 18 wherein the matrix material is selected from the group consisting of polymers or copolymers of acetals, acrylics, epoxy, latex polymers, melamines, nylons, phenolics, polycarbonates, polyesters, polyolefins (including, but not limited to, homopolymer of polyethylene of various densities, polypropylene and their blends and copolymers, and functionalised polyolefins with maleic anhydride, glycidyl methacrylate, etc), functionalised or non-functionalised polystyrene, polysulfones, polysulfides, polyurethanes, polyvinyl alcohol, polyvinyl chloride, poly(acrylonitrile-butadiene-styrene) (ABS), unvulcanized rubbers, silicons, unsaturated polyesters, urea formaldehydes, polymethyl methacrylate (PMMA), bitumen, asphalt, concrete, natural and synthetic rubbers and mixtures of two or more thereof.

20. A process according to claim 18 wherein the multifunctional amine containing organic compound is a polymer or copolymer containing a multiplicity of amine functional groups.

21. A process according to claim 20 wherein the polymer or copolymer containing a multiplicity of amine functional groups is amine terminated acrylonitrile-butadiene-styrene (ATBN).

22. A process according to claim 19 wherein the treated particulate rubber is contacted with the matrix in the presence of a lewis acid catalyst.

23. A process according to claim 21 wherein the lewis acid catalyst is aluminium chloride.

24. A process according to claim 19 wherein the matrix material is acrylonitrile-butadiene-styrene (ABS).
